(19) United States
(12) Patent Application Publication
(10) Pub. No.: US 2017/0048682 A1
(43) Pub. Date: Feb. 16, 2017

(54) ROUTING SCHEME SWITCHING

(71) Applicant: VODAFONE IP LICENSING LIMITED, Newbury, Berkshire (GB)

(72) Inventors: Youssef CHAMI, London (GB); Ian HILLS, London (GB)

(21) Appl. No.: 15/304,410

(22) PCT Filed: Apr. 14, 2015
(86) PCT No.: PCT/GB2015/051138

§ 371 Date: Oct. 14, 2016

(30) Foreign Application Priority Data
Apr. 15, 2014 (GB) 1406723.5
May 22, 2014 (GB) 1409161.5

(51) Int. Cl. H04W 4/06; H04W 68/02; H04L 12/18

(52) U.S. Cl. CPC H04W 4/06; H04L 12/189; H04W 68/02

(57) ABSTRACT

A routing scheme is set, for providing a communications service to a plurality of subscriber terminals in a cellular network. A service manager that is at least logically separate from the cellular network controls the communications service for the plurality of subscriber terminals. Information about one or both of: the plurality of subscriber terminals; and at least one characteristic of the cellular network is communicated between the cellular network and the service manager. A routing scheme for providing the communications service to the plurality of subscriber terminals is set based on the communicated information.

### TECHNICAL FIELD OF THE INVENTION

The invention relates to a method of setting a routing scheme for providing a communications service to a plurality of subscriber terminals in a cellular network and a network entity configured to set a routing scheme.

### BACKGROUND TO THE INVENTION

The Third Generation Partnership Project (3GPP) has been developing enhancements to cellular systems to allow their operation for public safety or emergency services (ES) communications. These are especially intended to work with the Long Term Evolution (LTE) architecture. Aims of this approach may include: reduced cost; improved functionality; and increased flexibility in comparison with existing public safety communication infrastructure, such as the Terrestrial Trunked Radio (TETRA) network.

Key functionalities for ES communications are Push to Talk (PTT) and Group Call communication. The existing architecture includes a number of data routing schemes, including multicast and unicast capabilities, which can be used for Group Call functionality. These are provided using the Multimedia Broadcast Multimedia Service (MBMS), which is known as eMBMS in LTE networks. Details of these may be found in 3GPP Technical Specification (TS) 22.468 v.12.0.0 and TS 23.768 v.12.0.0.

The decision on which routing scheme to use with existing MBMS or eMBMS configurations is made within the cellular network. For example, US-2013/028118 describes an MBMS approach for providing a service, in which the choice between a first, unicast mode and a second broadcast or multicast mode is made based on the number of subscribers using the service. This is information readily available to the cellular network, particularly at the lower networking layers that are primarily managed by the cellular network.

It is desirable to improve the way that this decision is made and its result, for example so that these functionalities can be implemented in a more intelligent and dynamic manner. This may especially help to meet the aims of ES communications discussed above.

### SUMMARY OF THE INVENTION

Against this background, the present invention provides a method of setting (or adjusting) a routing scheme for providing a communications service to a plurality of subscriber terminals in a cellular network. A service manager that is at least logically separate from the cellular network controls the communications service for the plurality of subscriber terminals. The method comprises: communicating between the cellular network and the service manager, information about one or both of: the plurality of subscriber terminals; and at least one characteristic of the cellular network; and setting (or adjusting) a routing scheme for providing the communications service to the plurality of subscriber terminals based on the communicated information.

In this way, the cellular network and the service manager can share information about the subscriber terminals using the communications service or one or more characteristics of the cellular network. This information can then be used to provide a cross-layer optimisation in order to make a decision on the choice of routing scheme. The service manager generally controls provision of the communications service in the higher layers of the networking protocol stack (application, possibly including presentation, session or both). The cellular network provides the lower layers of the networking protocol stack (which may include any one or more of: physical; data link; network; and transport). Thus, there may be a logical separation in the way that the service is managed and provided, with the service manager normally setting end-to-end parameters, for example Quality of Service (QoS) and the cellular network controlling provision of the service at the connectivity layers. By interfacing the logically separated functionalities, the upper layers can be jointly optimised with the lower layers. This may result in a decision being made with a better performance for the cellular network, communications service or both, in an efficient way. Flexibility and robustness of the cellular network, communications service or both may also be improved.

The service manager may be an external service provider. In embodiments, the service manager may be physically integrated with the cellular network, whilst remaining logically separate. In other cases, the service manager may be physically separate from the cellular network. The service manager may be part of a network that is external the cellular network. In some embodiments, the service manager may an application. The service manager and cellular network may be operated by the same network operator or by different operators.

Preferably, the routing scheme is chosen from a plurality of point-to-multipoint routing technologies. For instance the routing scheme may be chosen from any two or more of: unicast; multicast; and broadcast. Other types of routing scheme (such as geocast or anycast) may also be used. The routing scheme set may use more than one routing technology. For example, different subscribers may be set with different routing technologies. In one approach, the routing scheme may be set so that each cell applies a respective routing technology, possibly based on the subscribers communicating through that cell.

In the preferred embodiment, the cellular network has Multimedia Broadcast Multicast Service (MBMS) functionality, which may include enhanced MBMS (eMBMS) functionality. In particular, the cellular network may comprise a first Broadcast Multicast Service Centre (BM-SC) component. This may be interfaced to a second BM-SC component at the service manager, for example, in order to carry out at least part of the step of communicating.

The communications service may comprise user-plane traffic. The communications service may comprise a point-to-multipoint communications service, such as a Push to Talk (PTT) service, a Group Call (GC) service or both.

As discussed above, the communications service is preferably a public safety or an emergency communications service (ES communications service). This provides additional advantages, as the cross-layer optimisation can provide more flexibility and robustness, which may be important for such types of application. However, the skilled person will appreciate that alternative services using an service manager that controls the communications service may also be employed, for example streaming services, conference calling services and other point-to-multipoint services. The method steps may be carried out in the cellular network, at the service manager or a combination of the two. One or more network entities (which may be of the cellular network, service manager or both) may be involved in performing the method.

Beneficially, the method further comprises: checking the information against at least one predefined criterion, such as a threshold. The information may comprise a plurality of data elements. Preferably, the step of checking then comprises checking each data element against a respective predefined criterion. For example, each data element may have its own respective threshold. In the preferred embodiment, the information relates to a predetermined period of time (for instance, a time duration). More preferably in the case wherein the information comprises a plurality of data elements, each data element relates to a respective predetermined period of time. For example, a first data element may be determined with respect to a first time duration and a second data element may be determined with respect to a second time duration. In any event, the method may further comprise dynamically adjusting one or both of: the at least one predefined criterion; and the predetermined period of time, based on the information. In this way, a self-learning process may be used to optimise the decision making algorithm or algorithms.

Beneficially, the information about the plurality of subscriber terminals comprises one or more of: a type of application being used by the plurality of subscribers (or the specific application being used); the number of subscribers using the communications service; the number of subscribers using the communications service per cell of the cellular network; and a geographical location for the plurality of subscriber terminals (for example, in the coverage which geographical cell of the cellular network are they located).

Preferably, the information about the at least one characteristic of the cellular network comprises data that varies dynamically between at least two cells of the cellular network (or optionally between more than two cells, most cells, or even all cells of the cellular network). This variation may be based on (or in accordance with) historic performance data for the cellular network, predicted performance data for the cellular network or a combination of the two. Alternatively, the information about the at least one characteristic of the cellular network may comprise static data.

Advantageously, the information about the at least one characteristic of the cellular network comprises one or more of: a (traffic) load on the cellular network (uplink, download or both); one or more Quality of Service (QoS) parameters (such as a minimum bit rate, a minimum error rate or a minimum latency); a predicted performance for the cellular network; and whether each cell providing service to the plurality of subscriber terminals has point-to-multipoint capability. The predicted performance for the cellular network may comprise or be based on one or more of: a latency for the cellular network; and a throughput for the cellular network.

An interface between the cellular network and the service manager (in order to effect the step of communicating, for instance) may be provided by at least Application Programming Interface (API). Multiple APIs may also be used. Additionally or alternatively, standard cellular network interfaces (such as those defined by 3GPP) may be used.

The first BM-SC component may be specifically responsible, inter alia, for (i) time synchronization (e.g., managing the synchronization and/or the sync protocol); (ii) managing eMBMS services (and associated eMBMS cells) other than those provided by the second BM-SC—for example eMBMS services to be provided within the cellular network and which are not managed; (iii) managing eMBMS-related signalling and/or data flows within the cellular network; and (iv) interworking with the service provider and/or the second BM-SC component.

The second BM-SC component may be specifically responsible for controlling PTT related functionalities, in particular the eMBMS area for PTT services. Additionally, it may also be responsible for managing transition of data between the service provider and the cellular network, for example via one or more interfaces defined between them.

In particular, the routing scheme may be set by the first BM-SC component and/or the second BM-SC component. However, the setting of the routing scheme may be triggered by an application layer. For example, this may be an application server associated with the service provider. For example, for PTT services, the application server of the service provider may trigger the setting of the routing scheme. This trigger may also comprise indicating which routing scheme should be set based on decision criteria. In other words, the application server takes the decision on the routing scheme to be set, and one or both of the BM-SC components execute the decision by setting the routing scheme in accordance with the decision. The decision criteria may be selected by the service provider based on information provided by the cellular network. For example, this information may comprise number of users (PTT and/or non-PTT) within one or more cells, current load of cells which are candidate for supporting PTT service, and other information about the cellular network. This information may be passed via an API and/or other interfaces between the cellular network and the service provider. The trigger itself may be based on decision criteria (e.g., for example decision criteria subscribed in the IP). Further, the first BM-SC component and the second BM-SC component may be physically separated, or may simply be logically separated.

In another aspect, there is provided a computer program, configured to carry out any method as described herein, when operated by a processor. In particular, the methods described above may be implemented as a computer program comprising program instructions to operate a computer. The computer program may be stored on a computer-readable medium.

In a further aspect, there is provided a network entity configured to set a routing scheme for providing a communications service to a plurality of subscriber terminals in a cellular network. The network entity comprises: a network interface, arranged for communication between the cellular network and a service manager, the network interface being configured to communicate between the cellular network and the service manager information about one or both of: the plurality of subscriber terminals; and at least one characteristic of the cellular network; decision logic, configured to set a routing scheme for providing the communications service to the plurality of subscriber terminals based on the information communicated through the network interface. The service manager is at least logically separate from the cellular network and controls the communications service for the plurality of subscriber terminals.

The network entity may further comprise optional apparatus or structural features configured to implement any of the method steps as described herein.

The network entity may comprise a computer system. The computer system may include a processor such as a central processing unit (CPU). The processor may execute logic in the form of a software program. The computer system may include a memory including volatile and non-volatile storage medium. A computer-readable medium may be included to store the logic or program instructions. The different parts of the system may be connected using a network (e.g. wireless networks and wired networks). The computer system may include one or more interfaces. The computer system may contain a suitable operating system such as UNIX (including Linux), Windows (RTM), for example.

It should be noted that any feature described above may be used with any particular aspect or embodiment of the invention. Moreover, the combination of any specific apparatus, structural or method features is also provided, even if that combination is not explicitly disclosed.

### BRIEF DESCRIPTION OF THE DRAWINGS

The present invention may be put into practice in a number of ways and an embodiment will now be described by way of example only and with reference to the accompanying drawings, in which:

FIG. 1 shows a schematic diagram of a network architecture for a cellular network interfaced with an external service provider;

FIG. 2 schematically depicts a network entity configured to set a routing scheme in accordance with the invention; and

FIG. 3 is a schematic illustration of a decision algorithm that may be used with the network entity of FIG. 2, for example.

### DETAILED DESCRIPTION OF A PREFERRED EMBODIMENT

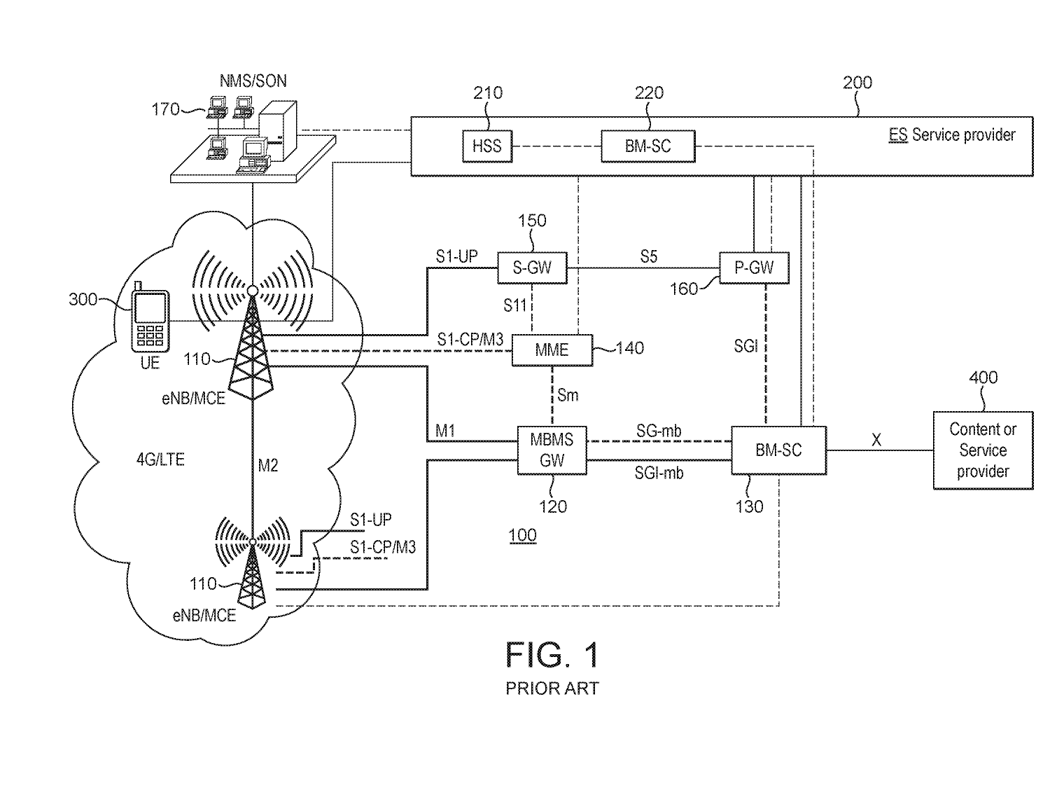

Referring first to FIG. 1, there is shown a schematic diagram of a network architecture for a cellular network 100 interfaced with an external service provider 200. In this case, the cellular network 100 has an LTE (E-UTRAN) architecture and the external service provider 200 is for Emergency Service (ES) communications, but these is simply illustrations.

The cellular network comprises: eNodeB (base station)/Multi-cell Coordination Entity (MCE) systems 110; a Multimedia Broadcast Multimedia Service (MBMS) Gateway (GW) 120; a network Broadcast Multicast Service Centre (BM-SC) 130; a Mobility Management Entity 140; a Serving Gateway (S-GW) 150; a Packet Data Network Gateway (P-GW) 160; and a Network Management Systems (NMS) and Self-Organising Network (SON) 170. Two eNodeB/MCE systems 110 are shown as an example, but it will be understood that more are typically present in a practical implementation. The external service provider 200 comprises: a Home Subscriber Server 210; and an external BM-SC 220. The User Equipment (UE) 300 interfaces with the external service provider 200 through the cellular network 100. In this context, a UE may be considered to include any subscriber-specific unit (such as a SIM card), application or data, in combination with a hardware communications device. The UE is normally serviced by one eNodeB/MCE system 110, but it may be served by multiple eNodeB/MCE systems 110 or simply be within the coverage area of multiple eNodeB/MCE systems 110. An external content or service provider 400 may also interface with the cellular network 100 via the network BM-SC 130.

This network architecture is adapted for providing enhanced MBMS (eMBMS) services. Interfaces between the network entities for providing such services are also shown and, where appropriate, labelled. The thin solid line between the UE 300 and external service provider 200 represents eMBMS user data. The thick solid lines represent eMBMS service and security layer data. The denser dashed lines (for example between the MME 140 and MBMS GW 120) represent eMBMS signalling and the thinner dashed lines (such as between the network BM-SC 130 and external BM-SC 220) represent eMBMS sync protocol.

LTE and similar cellular networks (such as the architecture depicted in FIG. 1) desirably control its resources and its services that a particular customer can use, especially when the content is being routed directly to or from an external company (particularly the external service provider 200) or the Internet. These controls can be effectively performed at a point where a traffic routing or switching decision is made. This may be governed by one or more than one network entity.

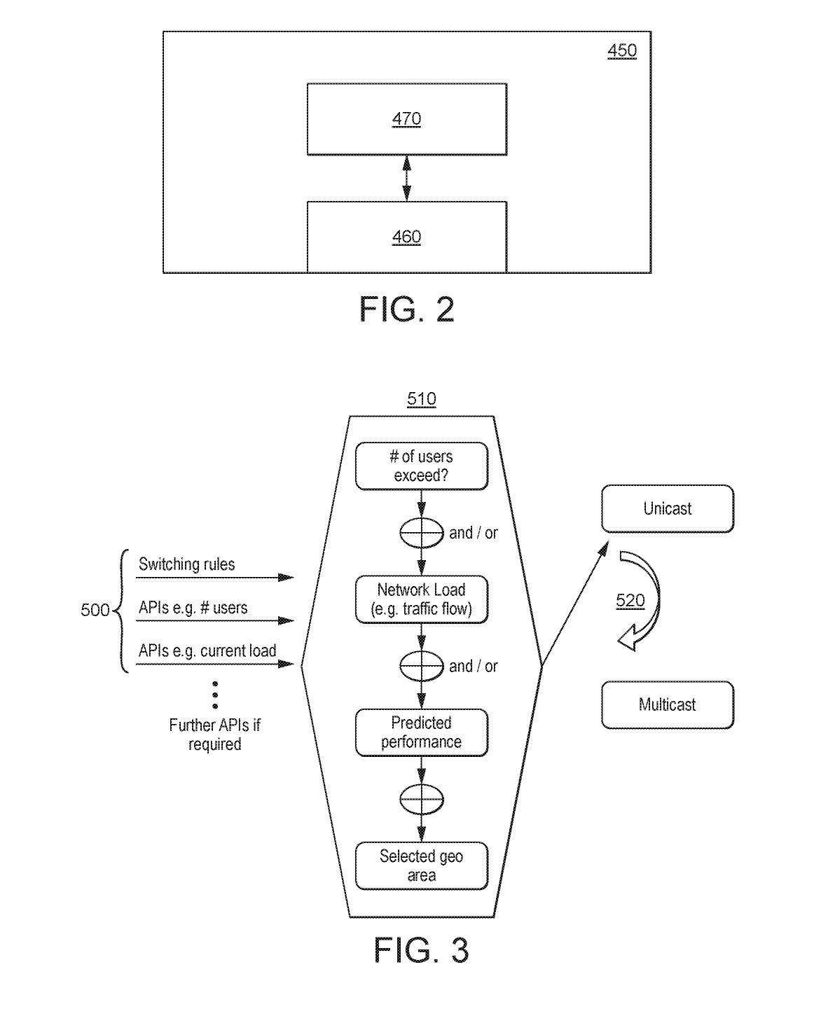

Referring next to FIG. 2, there is shown a schematic depiction of a network entity 450 configured to set a routing scheme. The network entity 450 may sit in the cellular network 100 or the external service provider 200. Alternatively, its functionality may be distributed between the two. The network entity 450 typically sits a point where a traffic routing or switching decision is made.

The network entity 450 comprises: a network interface 460; and decision logic 470. The network interface 460 provides communication between the cellular network 100 and the external service provider 200. This allows the communication of information between the cellular network 100 and the external service provider 200. The information relates to the UEs 300, characteristic or characteristics of the cellular network 100 or a combination of these.

Using the information communicated through the network interface 460, the decision logic 470 sets (or adjusts) a routing scheme used for providing communications service to the UEs. This decision process will be explained below.

This network entity 450 may facilitate communication between a cellular network 100 node, such as the P-GW 160 and a node of the external service provider 200, such as a GC (Group Call) Application Server (AS) connected to an eMBMS entity. The decision logic 470 at the network entity 450 is utilised and takes into account network information obtained from the cellular network, such as the P-GW 160 and MBMS entity (such as eMBMS GW 120) and determines when it is appropriate to switch routing scheme (that is, traffic type) between unicast and multicast or vice versa.

The decision to switch routing scheme may be based on a variety of different parameters. Some parameters may relate to the cellular network and others may concern the service provided to the UEs by the external service provider. Suitable parameters used may include: an application used; network load; number of connections or users of the network; performance information (such as latency); and QoS parameters or QoS Information. This information can be obtained using the standardised 3GPP interfaces, specific Application Programming Interfaces (APIs) between external service provider 200 nodes and cellular network 100 nodes.

This can allow tight integration of the Application layer (such as external service provider 200 OSI-reference model layers 5, 6, and 7) and the Network layer (for instance, cellular network 100 OSI-reference model layers 1, 2, 3 and 4), enabling Applications and the network to function effectively together to meet customer expectations. In other words, this may improve performance for the end user by increasing the synergy between the external service provider 200 nodes and the cellular network 100 nodes, thus enabling the switching decision between multicast and unicast to be performed effectively. Consequently, intelligent decisions can be made on the number of users, the used or available capacity and the flow of traffic based on the application or service used.

Referring next to FIG. 3, there is provided a schematic illustration of a decision algorithm that may be used with the network entity 450 (such as shown in FIG. 2), for example. The decision algorithm comprises: one or more inputs 500; decision logic 510; and output 520.

The inputs 500 may include any of the parameters discussed above. Switching rules may also be provided as inputs 500. In particular, the information related to the traffic, network load, and the number of ES users per cell/site/region which are taken by the cellular network 100 nodes can be passed to external service provider 200 network functions or platform through dedicated interfaces, such as APIs or 3GPP standardised means. The external service provider 200 can use such information to manage load to meet the QoS requirements for Push to Talk (PTT) and Group Call (GC) communications, for instance.

Allowing the external service provider 200 to have information about the users, the network or both will further enhance the ES user performance. For example, it may be possible to change the codec used or change the trigger to change from unicast to multicast. These changes can be made dynamically or manually through a dispatcher, for instance in the case of an event or to leave head-room resources during business hours or for specific locations.

The logic 510 makes the switching decision, in this case from unicast to multicast (or vice versa). The decision can be applied using single or multiple inputs 500. Each eMBMS entity may be able to decide which inputs 500 to use. The eMBMS entities may also decide which network functions should be provided by the Base station (eNodeB/MCE systems 110), MME 140, P-GW 160 and the UE 300. For instance, this may include number of users. Users at a cell coverage edge area may be switched to multicast within a single MBSFN area to avoid inter cell interference from neighbouring cell(s).

The logic 510 may use a variety of different rules, based on the inputs 500. As an example, the following rules may be applied.

1. Check to see if the number of users per cell exceeds a predefined threshold for a given duration (duration A).

2. Check to see if the network load exceeds a predefined threshold in Mbps for a second duration (duration B).

3. Check to see if the predicted performance is greater than (or is at least) a predefined performance threshold, (for example, latency in the network measured in ms or a given throughput threshold measured in Mbps).

4. Check to see if the service cell is eMBMS capable.

5. If any of 1, 2 or 3 is true AND 4 is true, then select multicast. Otherwise, select unicast.

Each of the thresholds and durations can be changed dynamically through a self-learning process using the information provided by the cellular network 100, the external service provider 200 or both, for instance through the interfaces described above.

For some Group calls, where the source and destination clients are in the same geographical region and are served by the same site or site cluster, the eMBMS platform (through the network entity 450) may ensure that the service is dynamically switched to multicast, especially if this is required to meet an Emergency Services' requirements.

Although a specific embodiment has now been described, the skilled person will understand that various modifications and variations are possible. For instance, the structure of the network entity may vary from that shown, for example being implemented in a distributed way. This may be distributed through more than one node of the cellular network 100, through more than one node of the external service provider 200 or through a combination or one or more node of the cellular network 100 together with one or more node of the external service provider 200.

The external service provider 200 need not be external to the cellular network. The cellular network 100 and the external service provider 200 can be physically integrated, for instance. The separation between the network BM-SC 130 and external BM-SC 220 may simply be a logical one, with internal communication being used between the external BM-SC part 220 managing the end-to-end service and the network BM-SC part 130 controlling the MBMS functionality.

The input 500 and the decision algorithm employed by the logic 510 may differ from those discussed above. For example, the information sought in steps 1 to 4 as discussed above may be combined in a different way to determine whether to use multicast. For example, more than one of steps 1 to 3 may need to be true for a multicast routing scheme to be employed. Other algorithms will be well-understood by the skilled person. Moreover, although switching between unicast and multicast has been shown, it will be understood that switching (or setting) other routing schemes may also be possible. Traffic types other than those shown may also be used.

Whilst the above details are discussed with reference to an ES communications service provider, it will be understood that other types of service may be employed using this approach, where an external service provider 200 is used.

1. A method of setting a routing scheme for providing a communications service to a plurality of subscriber terminals in a cellular network, the method comprising:
communicating between the cellular network and a service manager, information about one or both of: the plurality of subscriber terminals; and at least one characteristic of the cellular network; and
setting a routing scheme for providing the communications service to the plurality of subscriber terminals based on the communicated information; and
wherein the service manager is at least logically separate from the cellular network and controls the communications service for the plurality of subscriber terminals.

2. The method of claim 1, further comprising:
checking the information against at least one predefined criterion.

3. The method of claim 2, wherein the information comprises a plurality of data elements, the step of checking comprising checking each data element against a respective predefined criterion.

4. The method of any preceding claim, wherein the information comprises a plurality of data elements, each data element relating to a respective predetermined period of time.

5. The method of any one of claims 2 to 4, further comprising:
dynamically adjusting one or both of: the at least one predefined criterion; and the predetermined period of time, based on the information.

6. The method of any preceding claim, wherein the information about the plurality of subscriber terminals comprises one or more of: a type of application being used by the plurality of subscribers; the number of subscribers using the communications service; the number of subscribers using the communications service per cell of the cellular network; and a geographical location for the plurality of subscriber terminals.

7. The method of any preceding claim, wherein the information about the at least one characteristic of the cellular network comprises one or more of: a load on the cellular network; one or more Quality of Service, QoS, parameters; a predicted performance for the cellular network; and whether each cell providing service to the plurality of subscriber terminals has point-to-multipoint capability.

8. The method of claim 7, wherein the predicted performance for the cellular network is based on one or more of: a latency for the cellular network; and a throughput for the cellular network.

9. The method of any preceding claim, wherein the information about the at least one characteristic of the cellular network comprises data that varies dynamically between at least two cells of the cellular network.

10. The method of any preceding claim, wherein the routing scheme is chosen from two or more of: unicast; multicast; and broadcast.

11. The method of any preceding claim, wherein the cellular network has Multimedia Broadcast Multicast Service functionality.

12. The method of claim 11, wherein the cellular network comprises a first Broadcast Multicast Service Centre, BM-SC, component interfaced to a second BM-SC component at the service manager in order to carry out at least part of the step of communicating.

13. The method of any preceding claim, wherein the communications service is an emergency communications service.

14. A computer program, configured to carry out the method of any preceding claim when operated by a processor.

15. A network entity configured to set a routing scheme for providing a communications service to a plurality of subscriber terminals in a cellular network, the network entity comprising:
a network interface, arranged for communication between the cellular network and a service manager, the network interface being configured to communicate between the cellular network and the service manager information about one or both of: the plurality of subscriber terminals; and at least one characteristic of the cellular network; and
decision logic, configured to set a routing scheme for providing the communications service to the plurality of subscriber terminals based on the information communicated through the network interface; and
wherein the service manager is at least logically separate from the cellular network and controls the communications service for the plurality of subscriber terminals.
